(19) United States
(12) Patent Application Publication
(10) Pub. No.: US 2025/0380118 A1
(43) Pub. Date: Dec. 11, 2025

(54) Internet of things communication integration system and method for the same

(71) Applicant: WEN-JUI CHANG, Taichung City (TW)

(72) Inventor: WEN-JUI CHANG, Taichung City (TW)

(21) Appl. No.: 19/226,980

(22) Filed: Jun. 3, 2025

Related U.S. Application Data
(60) Provisional application No. 63/656,813, filed on Jun. 6, 2024.

(51) Int. Cl. H04W 4/70; G06F 3/04845; G06F 21/62; G16Y 10/75; G16Y 40/10; G16Y 40/35

(52) U.S. Cl. CPC H04W 4/70; G06F 3/04845; G06F 21/629; G16Y 10/75; G16Y 40/10; G16Y 40/35; G06F 2221/2141

(57) ABSTRACT

An Internet of Things communication integration system. Equipment is connected to a host computer via a data transmission method, and the host computer is further connected to a device through the same transmission method. A user can utilize the device to edit a customization module and a datafication module displayed on a user interface. Additionally, the user may establish process settings through a macro module and continuously track signal sources from the equipment via a monitoring system module. The Internet of Things communication integration system enables interface customization according to the user requirements, achieving an integrated platform for editing and execution functions.

### FIELD OF INVENTION

A communication system, in particular an internet of things communication integration system.

### BACKGROUND OF THE INVENTION

In prior art, Internet of Things (IoT) applications have been widely used in fields such as healthcare, manufacturing, and automation to achieve data collection and remote monitoring and control between devices. However, most existing machine-to-machine IoT system designs are based on fixed workflows and unified interfaces, lacking the capability for flexible adjustment, and are unable to customize data display formats, analysis procedures, or equipment control conditions according to the actual needs of different users (such as physicians, nursing personnel, or system administrators). This limitation leads to a suboptimal system usage experience and hinders improvements in clinical response efficiency and the quality of personalized care. Accordingly, providing a machine-to-machine IoT application architecture that enables users to adjust presentation methods and customize automated processes has become an urgent issue to be addressed in the industry.

### SUMMARY OF THE INVENTION

In view of the aforementioned technical issues, the present invention provides an Internet of Things communication integration system including at least one equipment, at least one port, a host computer, and at least one device. The equipment is configured to generate data based on an operation. Wherein, each of the ports is respectively connected to each of the equipment, and the host computer includes a central control center and a device management module. The device management module is connected to the central control center and corresponds to at least one of the ports, and at least one of the ports is configured to transmit the data generated by the equipment to the central control center via the device management module, and the central control center analyzes the data and generates at least one data model. Wherein, the device is connected to the host computer via a data transmission method and configured to receive at least one of the data model from the central control center, wherein the device comprises a user interface and a customization module, wherein the customization module displays at least one customization component on the user interface based on the data model, and the user interface is configured to select, according to an operation instruction, one of the equipment and the position, size, and color of the corresponding customization components on the user interface.

Wherein, the operation comprises dragging, selecting, and clicking.

Wherein, the data transmission method comprises a wired network, a wireless network, and a data transmission cable.

Wherein, the ports comprise barcode, NFC, wireless network, Bluetooth, USB, RS232, RS485, and RJ45.

Wherein, the user interface comprises an editing permission module, and the editing permission module controls an editing permission of a user for the user interface.

Wherein the device comprises a datafication module and a macro module, and the user interface with the editing permission is configured to display the datafication module and the macro module. Wherein, the datafication module comprises multiple datafication elements, and the datafication module is configured to display one or more of the datafication elements on the user interface based on the data model, and the user interface is configured to select one of the datafication elements based on the operation instruction; wherein the datafication elements comprise histograms, line charts, pie charts, tables, data labels, and range selectors.

Wherein, the macro module comprises multiple formula elements and multiple macro elements, and the macro module is configured to display one or more of the formula elements and the macro elements on the user interface based on the data model, and a formula and a process are edited and established in the macro module through the operation of the formula elements and the macro elements. Wherein, the formula elements comprise multiple operators and numerals, and the macro elements comprise flowcharts, icons, and parameter settings.

Wherein, the host computer comprises a monitoring system module, and the monitoring system module is signally connected to the central control center and continuously monitors the status of the host computer. Wherein, the monitoring system module comprises multiple listening port numbers, at least one of the listening port numbers corresponds to the device management module of the device, and continuously monitors signals from the equipment. Wherein, the host computer comprises a host connecting module, and the host connecting module connects the data from the equipment to the central control center through at least one communication protocol.

Wherein, the communication protocols include MODBUS, Message Queuing Telemetry Transport (MQTT), and OPC Unified Architecture (OPC UA).

Wherein, the host computer comprises a communication customization module, and the communication customization module is connected to the central control center, and the communication customization module is configured to analyze various communication protocols.

Wherein, the host computer comprises a cloud synchronization module, and the cloud synchronization module is connected to the central control center, and the cloud synchronization module synchronizes multiple devices via the central control center.

Furthermore, the present invention provides a method for using an Internet of Things communication integration system comprising steps of:
connecting at least one equipment to a host computer via a port;
installing the Internet of Things communication integration system on a device and connecting the device to the host computer via a data transmission method;
further, continuously transmitting the data measured by each equipment to the central control center of the host computer via the data transmission method, and then delivering the data to the device;
optionally, displaying a customization module, a datafication module, and a macro module on a user interface with editing permission, and customizing the user interface through an operation; and interpreting and executing protocol packets of the data generated via the communication port using a communication customization module.

Wherein, by editing the customization module one of the equipment and the corresponding custom components can be selected and to set the position, size, and color of the custom components on the user interface; by editing the datafication module, the way the data being presented can be customized; and by editing the macro module, formulae and processes can be created and edited.

Wherein, the corresponding listening port number for the equipment is selected and enabled through the customization module.

The present invention provides an Internet of Things communication integration system that enables the authorized users to customize the user interface 41 according to their needs, thereby enhancing the user experience and system flexibility of IoT devices. The Internet of Things communication integration system integrates and analyzes various communication protocols through the communication customization module 35 to enable intelligent environmental control. Furthermore, by means of the datafication module 43 and the macro module 44, combined with a visualization process design tool, the system offers the users a unified interface for operation and workflow configuration. This enhances the overall system flexibility and scalability and can be widely applied in various industries such as smart homes, industrial monitoring, and smart healthcare.

### BRIEF DESCRIPTION OF THE DRAWINGS

FIG. 1 is a system diagram of a preferred embodiment in accordance with the present invention;

FIG. 2 is a system diagram of a host computer of a preferred embodiment in accordance with the present invention;

FIG. 3 is a system diagram of a customization module of a preferred embodiment in accordance with the present invention;

FIG. 4 is a system diagram of a datafication module of a preferred embodiment in accordance with the present invention;

FIG. 5 is a system diagram of a macro module of a preferred embodiment in accordance with the present invention; and

FIG. 6 is a system diagram of a cloud synchronization module of a preferred embodiment in accordance with the present invention.

### DETAILED DESCRIPTION OF THE PREFERRED EMBODIMENTS

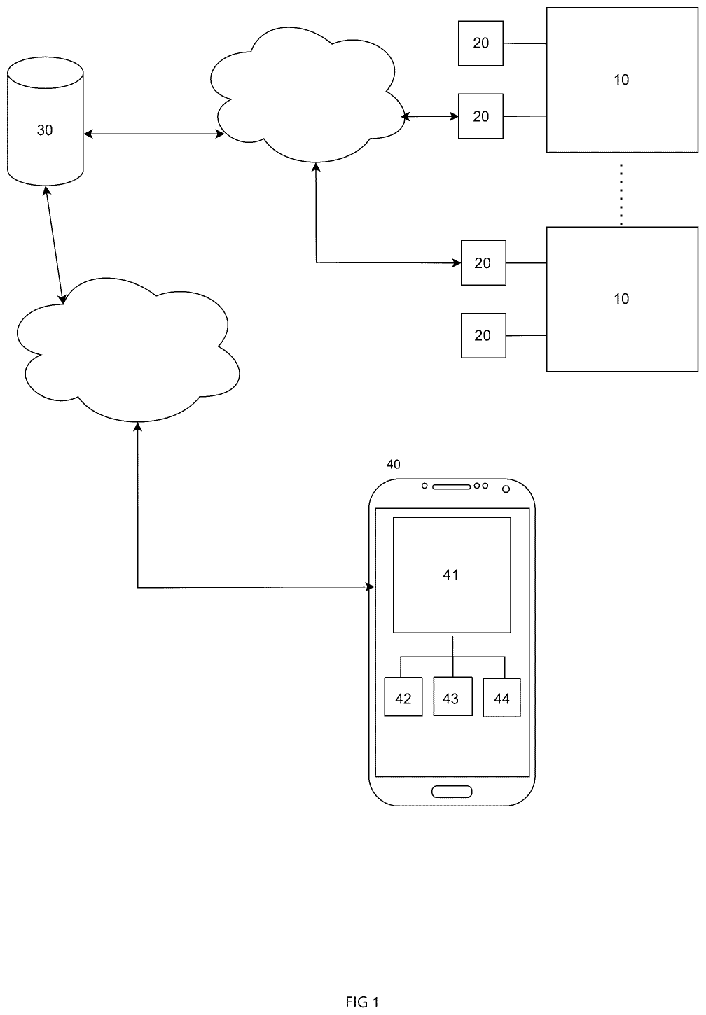

With reference to FIG. 1, the present invention provides an Internet of Things communication integration system comprising at least one equipment 10, at least one port 20, a host computer 30, and at least one device 40. Each equipment 10 is a different type of Internet of Things (IoT) equipment, and the equipment 10 includes, but is not limited to, one or more sensors and mechanical equipment. Each port 20 is respectively connected to each corresponding equipment 10.

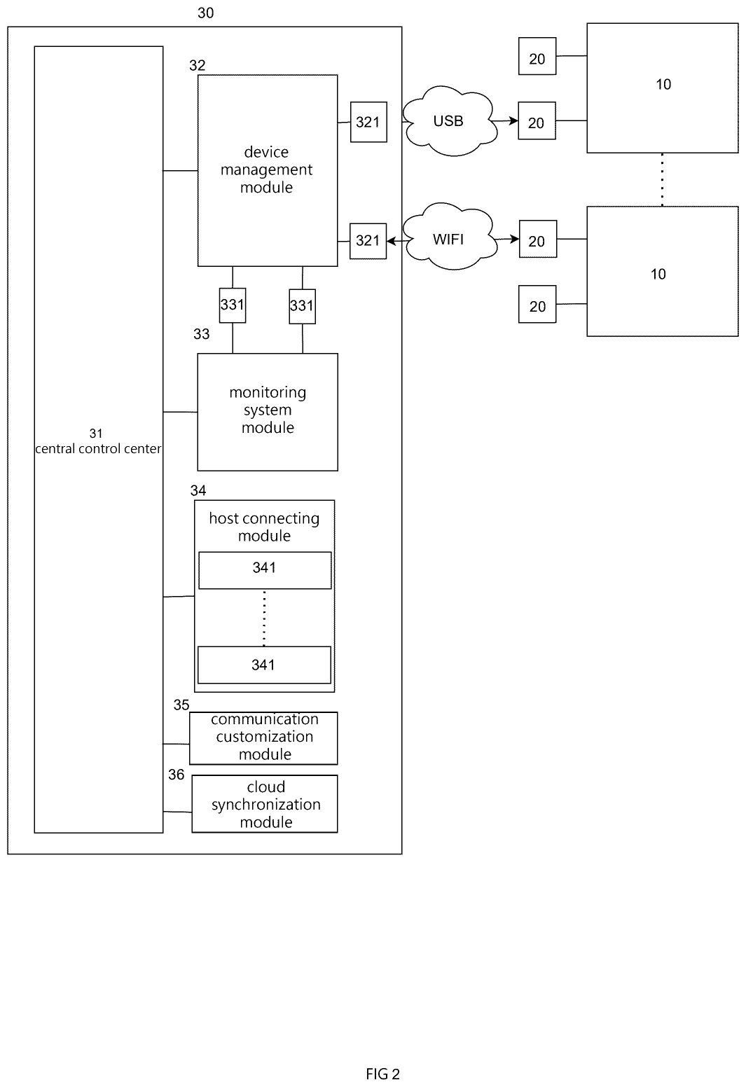

With reference to FIG. 2, the host computer 30 includes a central control center 31, a device management module 32, a monitoring system module 33, a host connecting module 34, a communication customization module 35, and a cloud synchronization module 36. The central control center 31 is included within the host computer 30 and is configured to aggregate, analyze, and determine the data and information obtained by the Internet of Things communication integration system. Furthermore, each equipment 10 is connected to the host computer 30 via the corresponding port 20, and data sensed by the equipment 10 is transmitted to the central control center 31 within the host computer 30 through a data transmission method. The data transmission method includes, but is not limited to, wired networks, wireless networks, and data transmission cables.

The device management module 32 is connected to the central control center 31 and transmits information to the central control center 31. Furthermore, through at least one type of communication transmission method, the device management module 32 is connected to the equipment 10, and at least one port 20 transmits the data from the equipment 10 to the central control center 31 via the device management module 32. The central control center 31 analyzes the data and generates one or more data models through machine learning. For example, the device management module 32 establishes a communication connection by using a camera to scan a barcode provided by the equipment 10. The device management module 32 includes multiple communication transmission methods, wherein the communication transmission methods include, but are not limited to, barcode scanning via camera, NFC, Bluetooth, wireless network, infrared, USB, RS232, RS485, and RJ45.

The monitoring system module 33 is connected to the central control center 31 and simultaneously monitors the local Central Processing Unit (CPU) and memory, thereby ensuring stable system operation. The monitoring system module 33 includes multiple listening port numbers 331, and each of the listening port numbers 331 comprises multiple communication protocols. The communication protocols include, but are not limited to, MODBUS, Message Queuing Telemetry Transport (MQTT), and OPC Unified Architecture (OPC UA). Each listening port number 331 is connected to the monitoring system 33 and transmits the monitored data to the monitoring system 33. Furthermore, the multiple listening port numbers 331 are respectively connected to the device management module 32, with each listening port number 331 corresponding to the device management module 32. In addition, each listening port number 331 listens for data provided by the respective port 20 through its corresponding communication protocol, providing real-time information on system resource usage.

The host connecting module 34 is communicatively connected to the central control center 31 and is capable of supporting multiple communication protocols. A user may operate the corresponding communication protocols respectively through multiple host connecting modules 34. The host connecting module 34 enables the user to control the Internet of Things communication integration system in more diverse ways, thereby enhancing the compatibility and scalability of the IoT communication integration system.

The communication customization module 35 is connected to the central control center 31. The communication customization module 35 is a packet communication mechanism capable of analyzing the respective communication protocols provided by the device management module 32 and the communication customization module 35 is used for intelligent environment control. The communication customization module 35 adapts to various smart control scenarios. Wherein, the control center 31 applies the communication customization module 35 to analyze the communication protocols of the device as an input basis of learning data during machine learning, and converts the data of the device 10 into one or more data models. The cloud synchronization module 36 is signal-connected to the central control center 31.

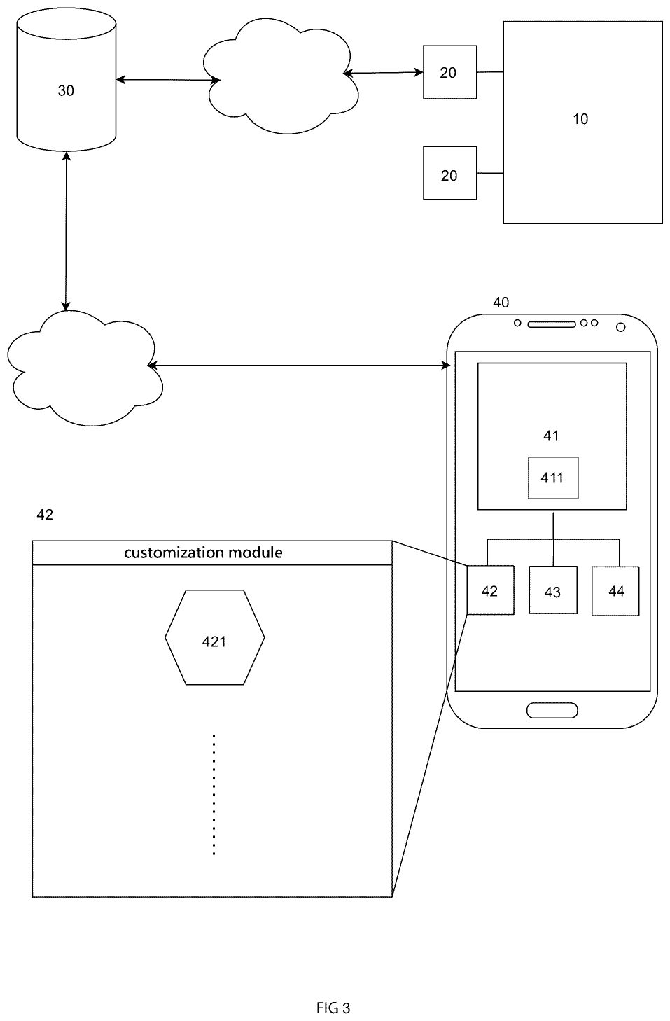

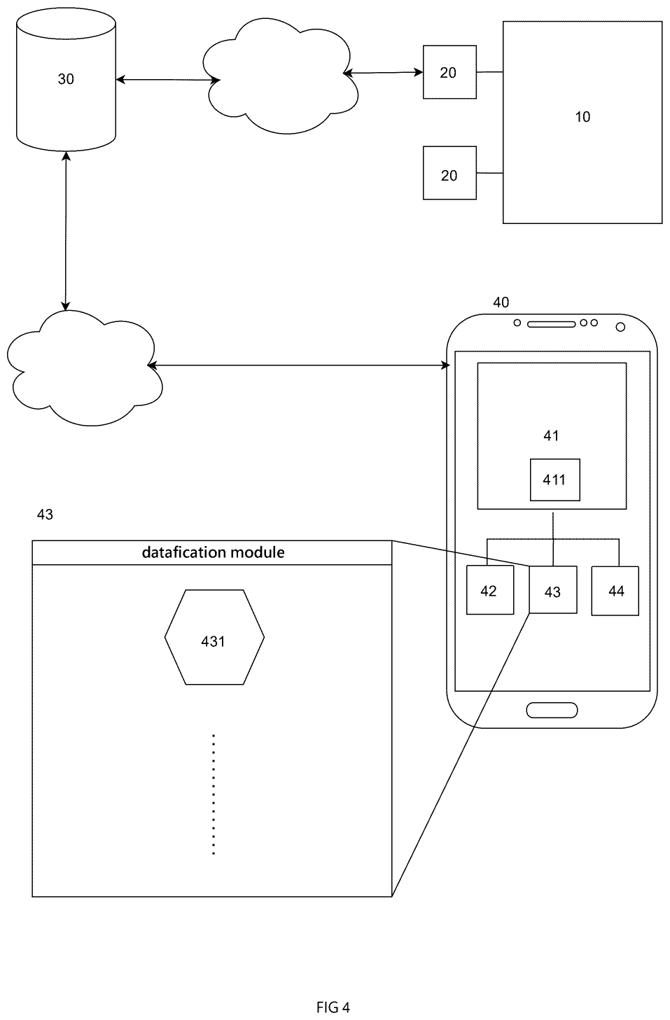

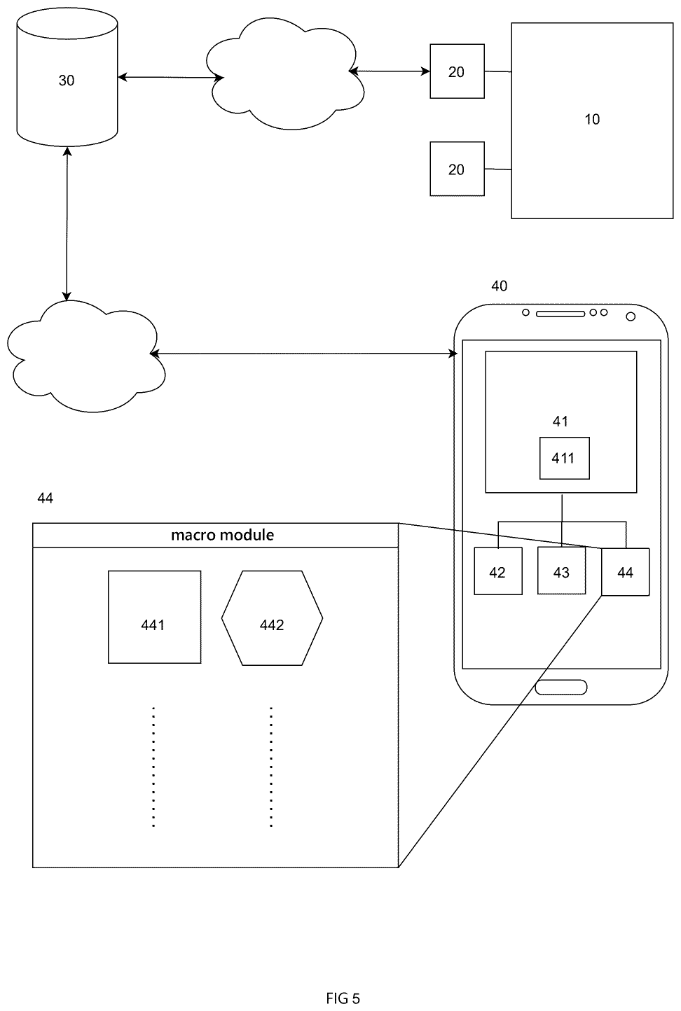

With reference to FIG. 1 and FIGS. 3 to 5, the device 40 may be connected to the host computer 30 via the data transmission method and receive one or more data models from the central control center 31 to further exchange the data/data models between the device 40 and the host computer 30. The device 40 includes a user interface 41, a customization module 42, a datafication module 43, and a macro module 44. The user interface 41 is a graphical user interface connected to the device 40. Furthermore, the device 40 transmits edited information provided by the user interface 41 and the data provided by the host computer 30 to each other via the data transmission method.

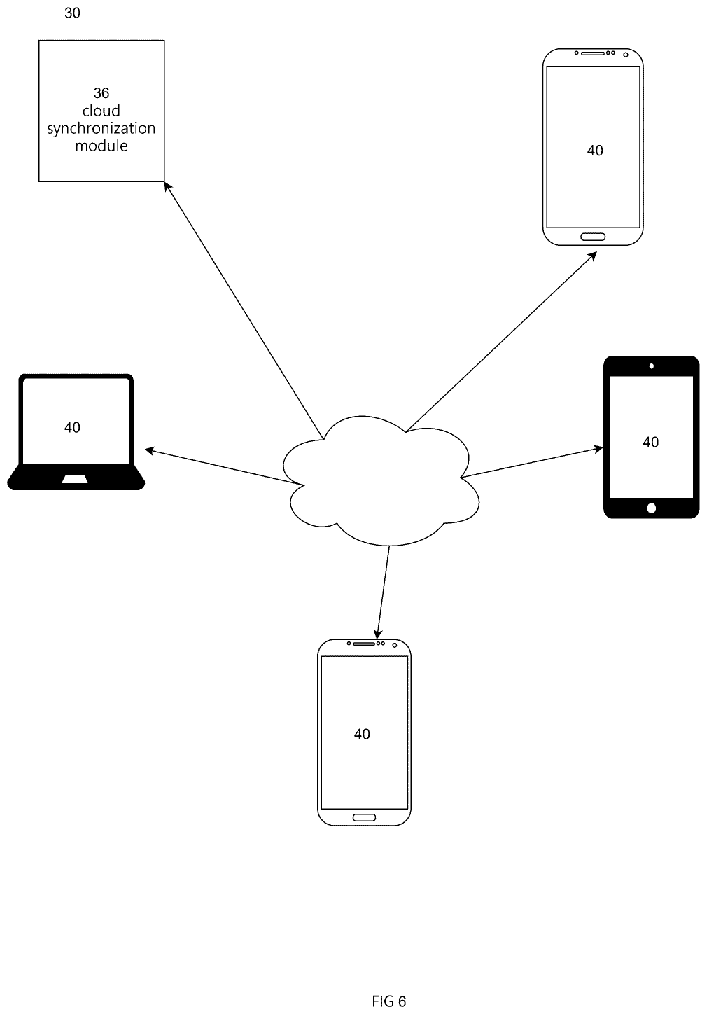

Furthermore, the user interface 41 includes an editing permission module 411. The editing permission module 411 manages editing permissions of the users, allowing only the users with the highest level of authority to have editing rights, thereby ensuring that only such users can adjust permissions or edit the interface. In addition, the users with general permission are only allowed to control the user interface 41. With reference to FIG. 6, through the data transmission method, the edited information of at least one device 40 is transmitted to the cloud synchronization module 36 and synchronized, so that the users do not need to re-edit the interface on multiple devices 40. The differences between the various permissions will be described in the following paragraphs.

The customization module 42 is signally connected to the user interface 41 and the customization module 42 receives the data transmitted from the host computer 30. Furthermore, the user interface 41 with editing permission displays the customization module 42. The customization module 42 includes multiple customization elements 421.

On the user interface 41 with editing permission, the customization module 42 displays one or more customization elements 421 on the user interface 41 according to the data model. The user interface 41, based on an operation instruction, selects one of the equipment 10 and sets the position, size, and color of each corresponding customization element 421 related to the equipment 10 on the user interface 41. The customization elements 421 include, but are not limited to, equipment selection, position, size, and color. The operations include, but are not limited to, dragging, selecting, clicking, etc.

At this time, the device 40 transmits the edited information from the customization module 42 to the host computer 30 via the data transmission method. The central control center 31 then determines whether to activate the listening port number 331 and retrieves the data provided by the equipment 10 to be displayed on the user interface 41.

The datafication module 43 is signally connected to the user interface 41 and the datafication module 43 receives the data transmitted from the host computer 30. Furthermore, the user interface 41 with editing permission displays the datafication module 43. The datafication module 43 includes multiple datafication elements 431. The datafication module 43 displays one or more datafication elements 431 on the user interface 41 according to the data model. The user interface 41 selects one of the datafication elements 431 on the user interface 41 based on the operation instruction. The datafication elements 431 include, but are not limited to, histograms, line charts, pie charts, tables, data labels, and range selectors.

Furthermore, the authorized user is able to edit the datafication module 43 on the user interface 41 by operating multiple datafication elements 431 and make multiple datafication elements 431 displayed on the user interface 41. Additionally, the device 40 transmits the edited information from the datafication module 43 to the host computer 30 via the data transmission method, and the central control center 31 analyzes the data provided by the equipment 10 for display on the user interface 41.

For example, the equipment 10 is a temperature sensor that continuously measures temperature data points in an environment and transmits the temperature data points back to the central control center 31 of the host computer 30. Meanwhile, the authorized user may use the device 40 to select the line chart as the display format in the datafication module 43. The central control center 31 analyzes the temperature data points according to the edited information, such that each of the temperature data points is displayed as a line chart on the user interface 41, thereby achieving real-time linkage with the equipment 10 and customized reception of data status.

The macro module 44 is signally connected to the user interface 41 and receives the data transmitted from the host computer 30. Furthermore, the user interface 41 with the editing permissions displays the macro module 44. The macro module 44 includes multiple formula elements 441 and multiple macro elements 442. The macro module 44 displays one or more formula elements 441 on the user interface 41 based on the data model, enabling users to operate, edit, and construct a formula within the macro module 44 using multiple formula elements 441. The formula elements 441 include, but are not limited to, multiple operators and numbers. The authorized user may further operate on the user interface 41 to edit the formula. The device 40 then transmits the edited data to the host computer 30. The central control center 31 integrates and computes the data received from the equipment 10 together with the edited information from the macro module 44, and displays a final result on the user interface 41.

The macro module 44 displays one or more macro elements 442 on the user interface 41 based on the data model, and through the operation multiple macro elements 442 can be edited and assembled to construct a process within the macro module 44. The macro elements 442 include, but are not limited to, flowcharts, icons, and parameter settings. Furthermore, the device 40 transmits the edited data to the host computer 30. The central control center 31 integrates, evaluates, and executes the data received from the equipment 10 together with the edited information from the macro module 44, and displays the status of the process on the user interface 41.

Furthermore, with reference to FIG. 1, steps of the operation of the Internet of Things communication integration system include:

Step 1: The host computer 30 and at least one equipment 10 are interconnected via the port 20 through a data transmission method. For example, multiple equipment 10 can be multiple medical equipment, and the port 20 is a wireless network interface. The medical equipment is connected to the Internet of Things communication integration system via the wireless network.

Step 2: Install the Internet of Things communication integration system on the device 40 and connect the device 40 to the host computer 30 via the data transmission method. The user interface 41 with editing permissions displays the customization module 42. Through the operation, one of the equipment 10 is selected and the position, size, and color of the corresponding customization elements 421 are customized on the user interface 41. The edited information is then transmitted to the host computer 30 via the data transmission method. Furthermore, through the customization module 42, the corresponding listening port number 331 for the selected equipment 10 is activated. The system continuously monitors the data from the equipment 10 to provide real-time status updates.

The data measured by each equipment 10 is continuously transmitted to the central control center 31 of the host computer 30 via the data transmission method, and then relayed to the device 40. For example, the device 40 may be a monitoring panel. Medical personnel install the Internet of Things communication integration system on the monitoring panel and connect the monitoring panel to the host computer 30 via a wireless network. Furthermore, based on a patient's condition, the medical personnel use the monitoring panel to select and activate the corresponding listening port numbers 331 of the equipment 10 that monitors physiological data such as blood oxygen, heart rate, or blood pressure respectively, thereby enabling continuous patient monitoring.

Step 3: Optionally, the user interface 41 with editing permissions displays the datafication module 43. The way the data are presented can then be customized through the datafication module 43. For example, the medical personnel may use the monitoring panel to customize the chart display of the patient's blood oxygen data, such as configuring to show a line chart illustrating the trend over the past 24 hours.

Step 4: Optionally, the user interface 41 with editing permissions displays the macro module 44. Formula or workflows can then be created, and the corresponding edited data can be transmitted to the host computer 30. Subsequently, the communication customization module 35 interprets the protocol packets provided by the device management module 32 of the device and executes the defined formula and workflows. The workflow may involve the host computer 30 issuing a command to the equipment 10, prompting the equipment 10 to perform a specific action. The command may include, but is not limited to: turning on, turning off, entering standby mode, or adjusting parameters. Based on the setting of editing permission module 411, the user with general permission can only adjust the user interface 41, but cannot create the formula or the workflows through the macro module 44.

For example, a medical personnel with editing permissions may use the user interface 41 of a terminal device to establish a monitoring workflow corresponding to a specific piece of equipment. When a patient enters a critical condition, the user interface 41 displays a notification to the medical personnel or to other terminal devices. The critical condition may include threshold settings for parameters such as heart rate, blood pressure, temperature, etc. The other terminal devices may be devices without editing permissions and are only capable of control the user interface 41.

The communication customization module 35 can support data parsing for multiple communication protocols. For example, the communication customization module 35 can parse the data from medical equipment via the MODBUS communication protocol to form multiple data models. These data include patient heart rate, blood pressure, and temperature as measured by the equipment. Once the monitoring workflow has been established, the medical personnel can use the customization module 42 on the terminal device to select one of the data models and configure its display position, size, and color on the user interface 41.

When the central control center 31 of the host computer 30 detects that the patient's heart rate falls below a predefined threshold, the host computer 30 issues a notification command to the device 40 or other devices and makes the equipment 10 automatically activates a notification mechanism to alert medical personnel, thereby enabling more accurate real-time diagnosis and care.

Although the equipment 10 itself includes a built-in alert mechanism for conditions of falling below preset threshold values, the Internet of Things communication integration system of the present invention enables the authorized medical personnel to customize monitoring conditions and alert thresholds. Moreover, notification content and display modes can be adjusted based on individual patient conditions. This customization, combined with real-time alerts issued via the user interface 41 of the terminal device, enhances the flexibility and accuracy of real-time diagnosis and care.

The Internet of Things communication integration system connects the equipment 10 to the host computer 30 via a data transmission method, and the host computer 30 is further connected to the device 40 through the data transmission method. The authorized users may edit the customization module 42 and the datafication module 43 via the device 40, and the customization module 42 and the datafication module 43 are displayed on the user interface 41. In addition, the authorized users may create workflows through the macro module 44 and continuously track signal sources from the equipment 10 via the listening system module 33.

The present invention provides an Internet of Things communication integration system that enables the authorized users to customize the user interface 41 according to their needs, thereby enhancing the user experience and system flexibility of IoT devices. The Internet of Things communication integration system integrates and analyzes various communication protocols through the communication customization module 35 to enable intelligent environmental control. Furthermore, by means of the datafication module 43 and the macro module 44, combined with a visualization process design tool, the system offers the users a unified interface for operation and workflow configuration. This enhances the overall system flexibility and scalability and can be widely applied in various industries such as smart homes, industrial monitoring, and smart healthcare.

What is claimed is:

1. An Internet of Things communication integration system comprising:
at least one equipment, wherein the equipment is configured to generate data based on an operation;
at least one port, wherein each of the ports is respectively connected to each of the equipment;
a host computer, comprising a central control center and a device management module, wherein the device management module is connected to the central control center and corresponds to at least one of the ports, and at least one of the ports is configured to transmit the data generated by the equipment to the central control center via the device management module, and the central control center analyzes the data and generates at least one data model through machine learning; and
at least one device, connected to the host computer via a data transmission method and configured to receive at least one of the data model from the central control center, wherein the device comprises a user interface and a customization module, wherein the customization module displays at least one customization component on the user interface based on the data model, and the user interface is configured to select, according to an operation instruction, one of the equipment and the position, size, and color of the corresponding customization components on the user interface.

2. The Internet of Things communication integration system according to claim 1, wherein the operation comprises dragging, selecting, and clicking.

3. The Internet of Things communication integration system according to claim 1, wherein the data transmission method comprises a wired network, a wireless network, and a data transmission cable.

4. The Internet of Things communication integration system according to claim 1, wherein the ports comprise barcode, NFC, wireless network, Bluetooth, USB, RS232, RS485, and RJ45.

5. The Internet of Things communication integration system according to claim 1, wherein the user interface comprises an editing permission module, and the editing permission module controls an editing permission of a user for the user interface.

6. The Internet of Things communication integration system according to claim 1, wherein the device comprises a datafication module and a macro module, and the user interface with the editing permission is configured to display the datafication module and the macro module.

7. The Internet of Things communication integration system according to claim 5, wherein the datafication module comprises multiple datafication elements, and the datafication module is configured to display one or more of the datafication elements on the user interface based on the data model, and the user interface is configured to select one of the datafication elements based on the operation instruction; wherein the datafication elements comprise histograms, line charts, pie charts, tables, data labels, and range selectors.

8. The Internet of Things communication integration system according to claim 7, wherein the macro module comprises multiple formula elements and multiple macro elements, and the macro module is configured to display one or more of the formula elements and the macro elements on the user interface based on the data model, and a formula and a process are edited and established in the macro module through the operation of the formula elements and the macro elements.

9. The Internet of Things communication integration system according to claim 8, wherein the formula elements comprise multiple operators and numerals, and the macro elements comprise flowcharts, icons, and parameter settings.

10. The Internet of Things communication integration system according to claim 1, wherein the host computer comprises a monitoring system module, and the monitoring system module is signally connected to the central control center and continuously monitors the status of the host computer.

11. The Internet of Things communication integration system according to claim 10, wherein the monitoring system module comprises multiple listening port numbers, at least one of the listening port numbers corresponds to the device management module of the device, and continuously monitors signals from the equipment.

12. The Internet of Things communication integration system according to claim 1, wherein the host computer comprises a host connecting module, and the host connecting module connects the data from the equipment to the central control center through at least one communication protocol.

13. The Internet of Things communication integration system according to claim 12, wherein the communication protocols include MODBUS, Message Queuing Telemetry Transport (MQTT), and OPC Unified Architecture (OPC UA).

14. The Internet of Things communication integration system according to claim 1, wherein the host computer comprises a communication customization module, and the communication customization module is connected to the central control center, and the communication customization module is configured to analyze various communication protocols.

15. The Internet of Things communication integration system according to claim 1, wherein the host computer comprises a cloud synchronization module, and the cloud synchronization module is connected to the central control center, and the cloud synchronization module synchronizes multiple devices via the central control center.

16. A method for using an Internet of Things communication integration system comprising steps of:
connecting at least one equipment to a host computer via a port;
installing the Internet of Things communication integration system on a device and connecting the device to the host computer via a data transmission method;
further, continuously transmitting the data measured by each equipment to the central control center of the host computer via the data transmission method, and then delivering the data to the device;
optionally, displaying a customization module, a datafication module, and a macro module on a user interface with editing permission, and customizing the user interface through an operation; and
interpreting and executing protocol packets of the data generated via the communication port using a communication customization module.

17. The method for using an Internet of Things communication integration system according to claim 16, wherein by editing the customization module one of the equipment and the corresponding custom components can be selected and to set the position, size, and color of the custom components on the user interface; by editing the datafication module, the way the data being presented can be customized; and by editing the macro module, formulae and processes can be created and edited.

18. The method for using an Internet of Things communication integration system according to claim 16, wherein the corresponding listening port number for the equipment is selected and enabled through the customization module.
